(19) United States
(12) Patent Application Publication
(10) Pub. No.: US 2008/0155480 A1
(43) Pub. Date: Jun. 26, 2008

(54) METHODS AND APPARATUS FOR GENERATING WORKFLOW STEPS USING GESTURES

(75) Inventors: Adriaan Van Wyk, Strubensvalley (ZA); Natachya Raath, Vanderbijlpark (ZA); Lenz le Roux, Radiokop (ZA); Wynand du Toit, Little Falls (ZA); Ben Fourie, Radiokop (ZA); Schalk de Jager, Weltevreden Park (ZA); Pieter Janson, Centruion (ZA); Olaf Wagner, Issaquah, WA (US)

Correspondence Address: BELL, BOYD & LLOYD, LLP, P.O. Box 1135, CHICAGO, IL, 60690, US

(73) Assignee: SOURCECODE TECHNOLOGY HOLDING, INC., Redmond, WA (US)

(21) Appl. No.: 11/945,894

(22) Filed: Nov. 27, 2007

Related U.S. Application Data
(60) Provisional application No. 60/939,281, filed on May 21, 2007.
(60) Provisional application No. 60/867,344, filed on Nov. 27, 2006.

(51) Int. Cl. G06F 3/033

(52) U.S. Cl. 715/863

(57) ABSTRACT

The present disclosure provides methods and apparatuses for generating workflow activities using gestures. Using the methods and apparatus herein, users can use gestures of the input device to create workflow activities. This allows users to quickly and intuitively create new workflow activities.

### CROSS-REFERENCE TO RELATED APPLICATIONS

The present application claims benefit to U.S. Patent Application No. 60/867,344, METHOD AND APPARATUS FOR CREATING WORK FLOW, filed on Nov. 27, 2006; and U.S. Patent Application No. 60/939,281, METHODS AND APPARATUS FOR GENERATING WORKFLOW STEPS USING GESTURES, filed on May 21, 2007, the entire contents of which are incorporated herein by reference.

### BACKGROUND

A business process is a combination of operational steps or activities that a business undertakes. A business may conduct a high number of business processes throughout the course of a day or year, in order to accomplish the business's goals. An operational step or activity may be any action from the mundane to the complex.

Through the use of technology, businesses can now model their business processes in a graphical nature. What used to be a loosely defined set of procedures can now be formalized into complex business process workflows. The formalized business processes allow managers to understand the bottlenecks of a process, and to redesign the business processes for efficiency.

Businesses can now also incorporate business process design into their existing technology systems. Instead of providing a simple map of a business process, integration with computer systems allows business process designers to design interactive business processes that drive business workflow. Business process designers can receive data from various sources and perform a wide range of actions on the data directly, and create business processes in an easy to understand visual manner.

Businesses create workflows as a part of business process design to assist in managing their internal operations. Business processes allow users to represent the current state of their business operations in a graphical manner. Users can also simulate new business operations through the use of business processes.

Some business process designers use graphical business process design software to create graphical workflows. The graphical software may use graphical objects to represent business processes and workflow activities. The business process designer typically uses an input device, such as a mouse, to select the graphical objects, from a list of common objects, to incorporate into the workflow. However, using the input device in this manner may be time consuming when dealing with a large amount of graphical objects.

### SUMMARY

The present disclosure provides methods and apparatuses for generating workflow activities using gestures. Using the methods and apparatus herein, users can use gestures of the input device to create workflow activities. This allows users to quickly and intuitively create new workflow activities.

Additional features and advantages are described herein, and will be apparent from, the following Detailed Description and the figures.

### BRIEF DESCRIPTION OF THE FIGURES

FIG. 1 is a high level block diagram of an example business process design system.

FIG. 2 is a more detailed block diagram showing one example of a client device.

FIG. 3 is a more detailed block diagram showing one example of a server.

FIG. 4 is an example screenshot of a gesture on a blank canvas.

FIG. 5 is an example screenshot of a gesture becoming a workflow activity.

FIG. 6 is an example screenshot of performing a gesture on an activity.

FIG. 7 is an example screenshot of a gesture becoming an event.

FIG. 8 is an example screenshot of performing a gesture between two activities.

FIG. 9 is an example screenshot of a gesture becoming a workflow path.

### DETAILED DESCRIPTION

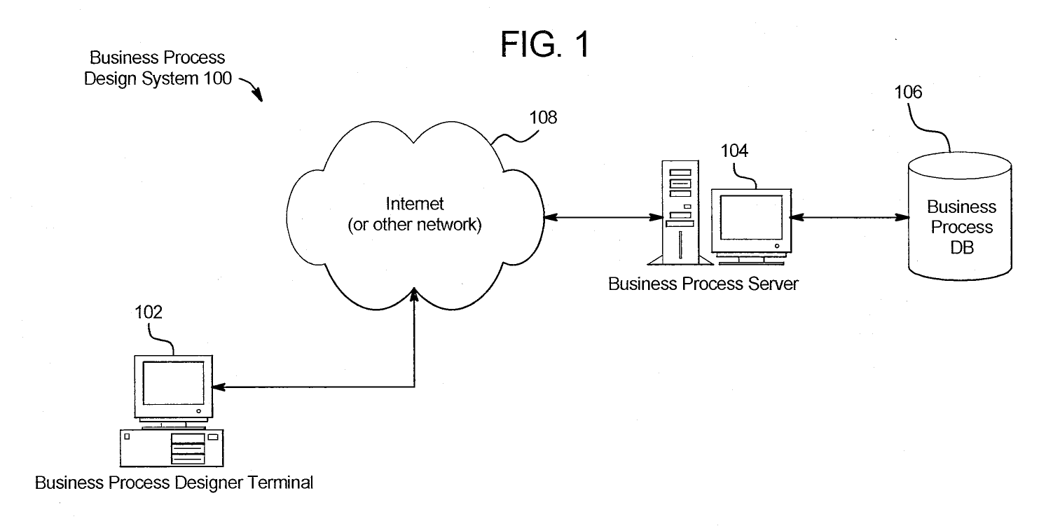

The present system is most readily realized in a network communications system. A high level block diagram of an exemplary network communications system 100 is illustrated in FIG. 1. The illustrated system 100 includes one or more business process designer terminals 102, one or more business process servers 104, and one or more business process databases 106. Each of these devices may communicate with each other via a connection to one or more communications channels 108 such as the Internet or some other data network, including, but not limited to, any suitable wide area network or local area network. It will be appreciated that any of the devices described herein may be directly connected to each other instead of over a network.

The business process server 104 stores a plurality of files, programs, and/or web pages in one or more business process databases 106 for use by the business process designer terminals 102. The business process database 106 may be connected directly to the business process server 104 or via one or more network connections. The business process database 106 preferably stores business process data.

One business process server 104 may interact with a large number of business process designer terminals 102. Accordingly, each business process server 104 is typically a high end computer with a large storage capacity, one or more fast microprocessors, and one or more high speed network connections. Conversely, relative to a typical business process server 104, each business process designer terminal 102 typically includes less storage capacity, a single microprocessor, and a single network connection.

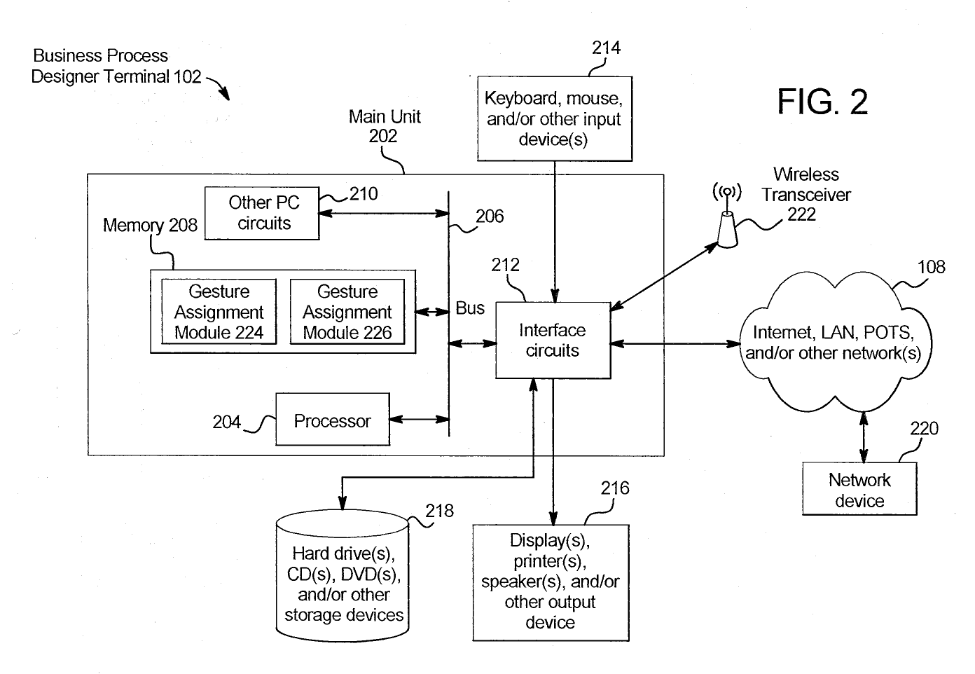

A more detailed block diagram of a business process designer terminal 102 is illustrated in FIG. 2. The business process designer terminal 102 may include a personal computer (PC), a personal digital assistant (PDA), an Internet appliance, a cellular telephone, or any other suitable communication device. The business process designer terminal 102 preferably includes a main unit 202 which preferably includes one or more processors 204 electrically coupled by an address/data bus 206 to one or more memory devices 208, other computer circuitry 210, and one or more interface circuits 212. The processor 204 may be any suitable processor, such as a microprocessor from the INTEL PENTIUM® family of microprocessors. The memory 208 preferably includes volatile memory and non-volatile memory. Preferably, the memory 208 stores a software program that interacts with one or more of the other devices in the system 100 as described below. This program may be executed by the processor 204 in any suitable manner. The memory 208 may also store digital data indicative of documents, files, programs, web pages, etc. retrieved from one or more of the other devices in the system 100 and/or loaded via an input device 214. Preferably, the memory 208 stores a software program that implements all or part of the method described below.

In particular, the memory 208 preferably stores a gesture interpretation module 224 and a gesture assignment module 226. The gesture interpretation module 224 may receive input signals from the input device 214. For example, a mouse may transmit a signal indicating the mouse's position and movement to the memory gesture interpretation module 224 via the interface circuits 212 and bus 206. The gesture interpretation may retrieve gesture assignments from the store device 218 and determine which workflow object the user intends to place in the workflow.

Mouse gestures may represent any of the standard workflow components. For example, mouse gestures may be used to represent activities, steps, paths, lines, events, etc.

The gesture assignment module 226 may receive input signals from the input device 214 indicating that the user wishes to create a new assignment of a gesture to a workflow object. The gesture assignment module 226 may also receive input signals from the input device 214 indicating a gesture, but the gesture may not be associated with a workflow object. The gesture assignment module 226 may then create a gesture assignment record in the storage device 218. For example, the user may enter a gesture assignment mode on the Business Process Designer Terminal 102. The user may then perform an “A” gesture using a mouse. The user may then select that the “A” gesture be associated with creating a default activity. The gesture assignment module 226 may then store the assignment in the storage device 218. The user may be able to assign gestures to any type of workflow object. For example, gestures may be associated with activities, lines, steps, paths, events, etc.

The gesture assignment module 226 may also access a configuration file. The configuration file may contain several gestures and allow a user to set a workflow object. For example, the configuration file may contain an indicator for a gesture representing “A” and allow the user to assign a default activity to the “A” gesture. The configuration file may also contain preset gesture associations. The gesture assignment module 226 may then store the assignment in the storage device 218. The user may be able to assign gestures to any type of workflow object. For example, gestures may be associated with activities, lines, steps, paths, events, etc.

Mouse button inputs or other input device inputs can be incorporated into the gesture assignment. For example, holding down a left mouse button and performing a gesture may produce one type of business process object, while holding down a right mouse button and performing a gesture may produce another type of business process object. Mouse gestures coupled with inputs 214 may produce different gestures. For example, holding down an “Alt” key on a keyboard and performing a gesture may be associated with a workflow activity, a menu item, a command, etc. The gesture assignment module 226 may also assign gestures to menu items. For example, the gesture assignment module 226 may assign the gesture for a character “E” to the “Event” objects, and a subsequent gesture to “M” may then be associated with the mail event.

These software modules 224, and 226 may be executed by the processor 204 in a conventional manner. However, some of the acts described in the method below may be performed manually or without the use of the business process designer terminal 102.

The interface circuit 212 may be implemented using any suitable interface standard, such as an Ethernet interface and/or a Universal Serial Bus (USB) interface. One or more input devices 214 may be connected to the interface circuit 212 for entering data and commands into the main unit 202. For example, the input device 214 may be a keyboard, mouse, touch screen, track pad, track ball, isopoint, and/or a voice recognition system.

One or more displays, printers, speakers, and/or other output devices 216 may also be connected to the main unit 202 via the interface circuit 212. The display 216 may be a cathode ray tube (CRTs), liquid crystal displays (LCDs), or any other type of display. The display 216 generates visual displays of data generated during operation of the business process designer terminal 102. For example, the display 216 may be used to display web pages received from the business process server 104. The visual displays may include prompts for human input, run time statistics, calculated values, data, etc.

One or more storage devices 218 may also be connected to the main unit 202 via the interface circuit 212. For example, a hard drive, CD drive, DVD drive, and/or other storage devices may be connected to the main unit 202. The storage devices 218 may store any type of data used by the business process designer terminal 102. The storage device 218 may store gesture assignments. For example, the gesture assignment module 226 may store a user's gesture assignments into the storage device 218.

The business process designer terminal 102 may also exchange data with other network devices 220 via a connection to the network 112. The network connection may be any type of network connection, such as an Ethernet connection, digital subscriber line (DSL), telephone line, coaxial cable, etc. Users of a business process designer terminal 102 may be required to register with the business process server 104. In such an instance, each user of a business process designer terminal 102, may choose a user identifier (e.g., e-mail address) and a password which may be required for the activation of services. The user identifier and password may be passed across the network 108 using encryption built into the business process designer terminal 102 browser. Alternatively, the user identifier and/or password may be assigned by the business process server 104.

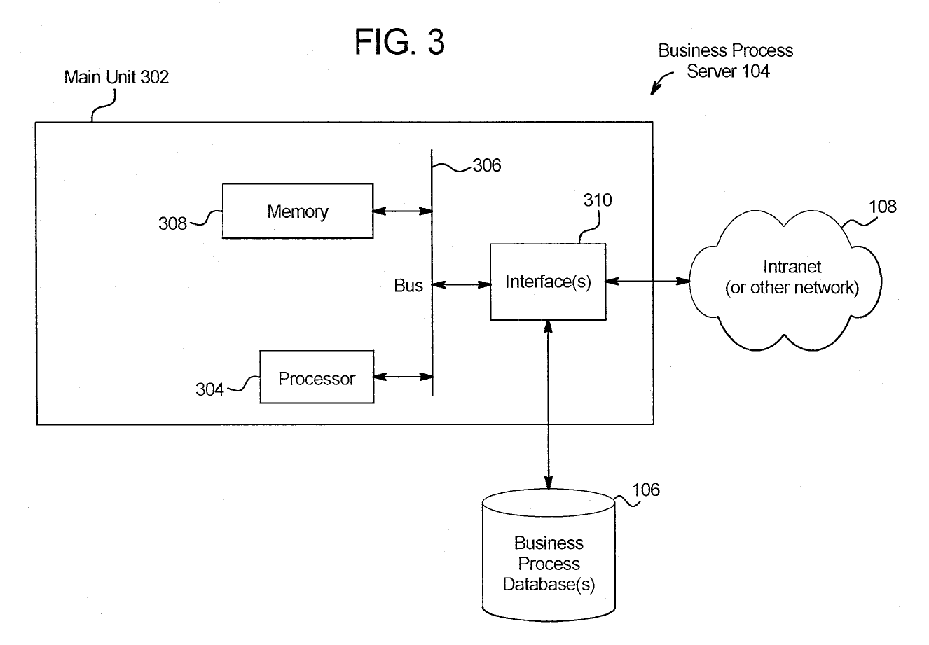

A more detailed block diagram of a business process server 104 is illustrated in FIG. 3. Like the business process designer terminal 102, the main unit 302 in the business process server 104 preferably includes one or more processors 304 electrically coupled by an address/data bus 306 to a memory device 308 and a network interface circuit 310. The network interface circuit 310 may be implemented using any suitable data transceiver, such as an Ethernet transceiver. The processor 304 may be any type of suitable processor, and the memory device 308 preferably includes volatile memory and non-volatile memory.

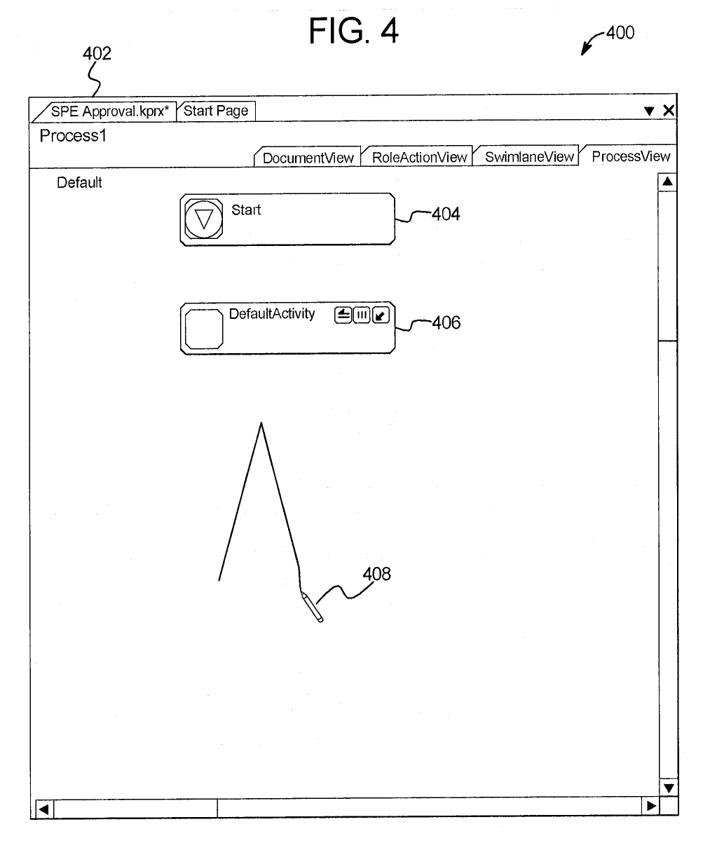

A screenshot of an example gesture on a blank canvas 400 is presented in FIG. 4. Although the example gesture on a blank canvas 400 is described in reference FIG. 4, it will be appreciated that many other configurations are possible. For example, elements could be in different locations, elements could have different names, and elements could have different graphical representations.

A business process designer working on a business process designer terminal 102 may use graphical business process design software to create a workflow. The business process design software may contain a canvas 402 for diagramming the workflow. For example, the business process design software may display a generally blank surface for placing objects representing workflow activities.

The canvas 402 may contain workflow activities. The workflow activities may include a start activity 404, default activity 406 etc. The business process designer may wish to add another workflow activity. For example, the business process designer may wish to add a default activity to the canvas 402. The user may use the input device 214 to create a gesture 408. For example, the business process designer may use a mouse to draw a figure “A” on a blank space on the canvas 402.

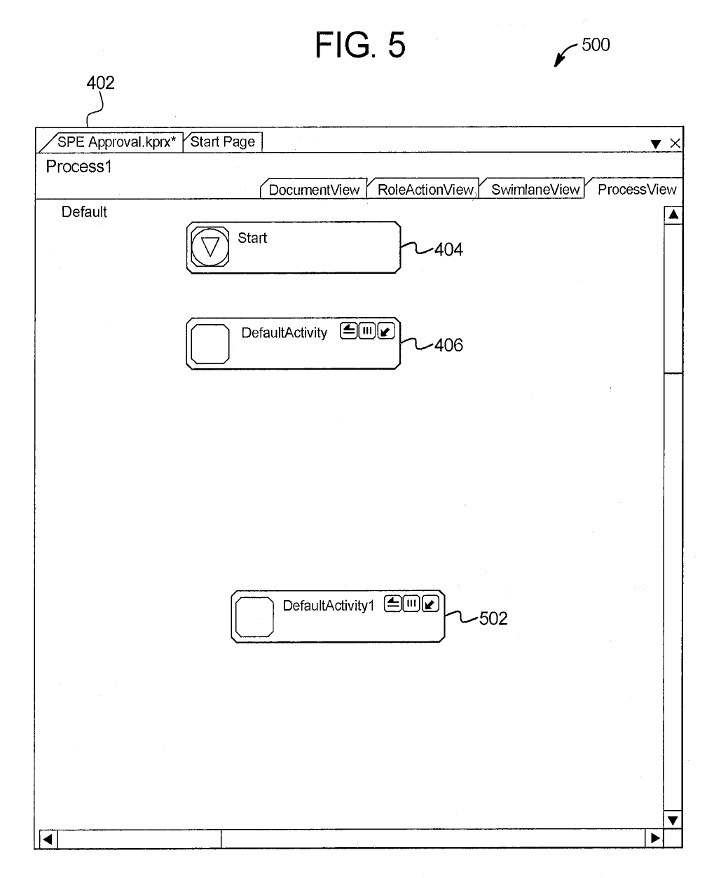

A screenshot of an example gesture becoming a workflow activity 500 is presented in FIG. 5. Although the example gesture becoming a workflow activity 500 is described in reference FIG. 5, it will be appreciated that many other configurations are possible. For example, elements could be in different locations, elements could have different names, and elements could have different graphical representations.

The gesture interpretation module 224 may receive the gesture 402 and determine the associated workflow activity. For example, the gesture interpretation module 224 may search the storage unit 218 for a workflow activity that corresponds to the gesture “A” and determine that the associated workflow activity is the default activity. The gesture interpretation module 224 may then cause a new default activity 502 to appear on the canvas 402.

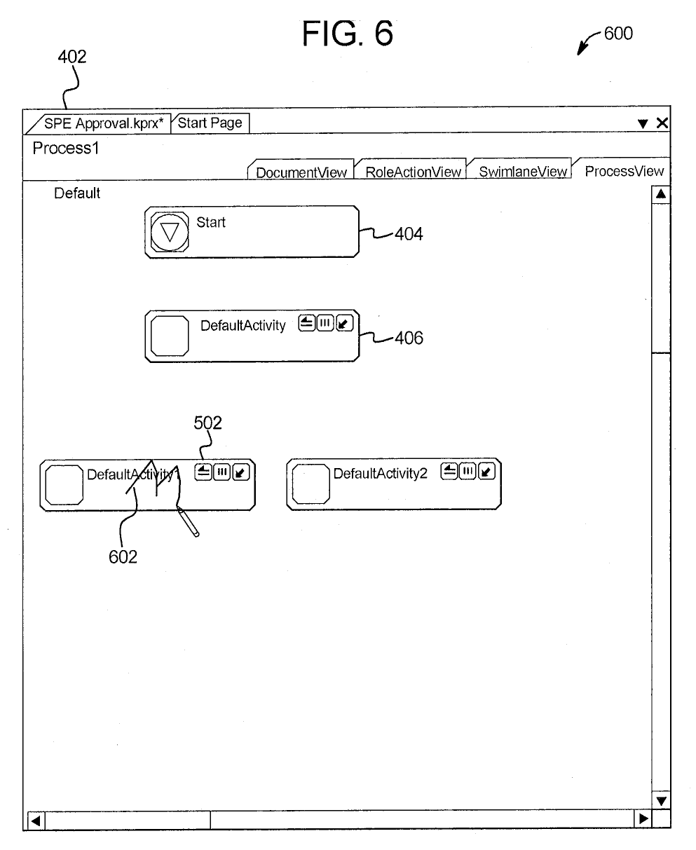

A screenshot of an example performing a gesture on an activity 600 is presented in FIG. 6. Although the example performing a gesture on an activity 600 is described in reference FIG. 6, it will be appreciated that many other configurations are possible. For example, elements could be in different locations, elements could have different names, and elements could have different graphical representations.

A business process designer may wish to create a workflow activity based on an existing workflow activity. For example, the business process designer may wish to create a Mail Event on a default activity 502. The business process designer may create a gesture 602 on the default activity 502. For example, the business process designer may use the mouse to draw an “M” on the default activity 502.

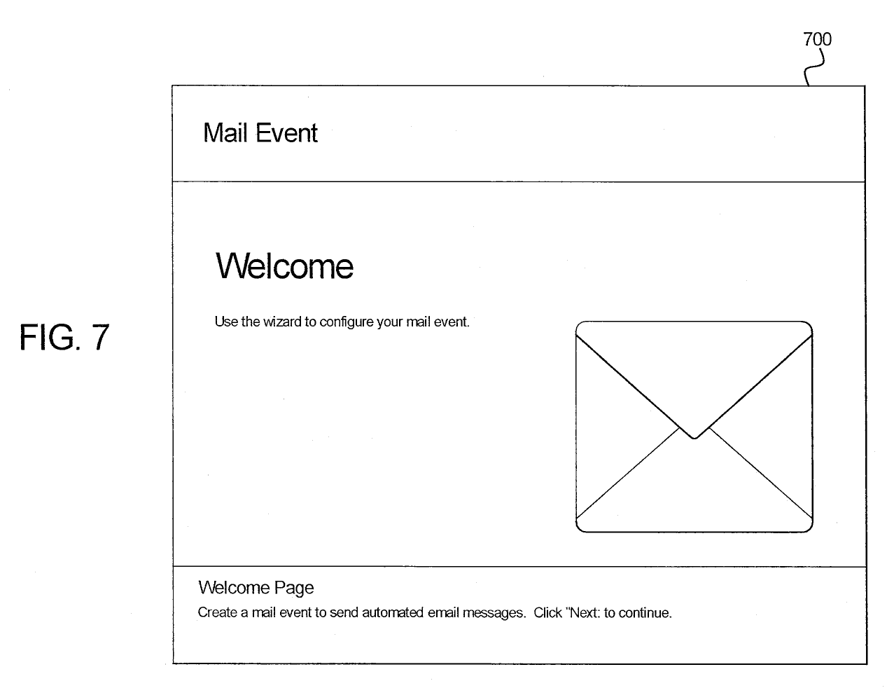

The gesture interpretation module 224 may receive the gesture 602 and determine the associated workflow activity. For example, the gesture interpretation module 224 may search the storage unit 218 for a workflow activity that corresponds to the gesture “M” and determine that the associated workflow activity is the mail event. The gesture interpretation module 224 may then cause a new mail event configuration wizard 700 to appear as shown in FIG. 7.

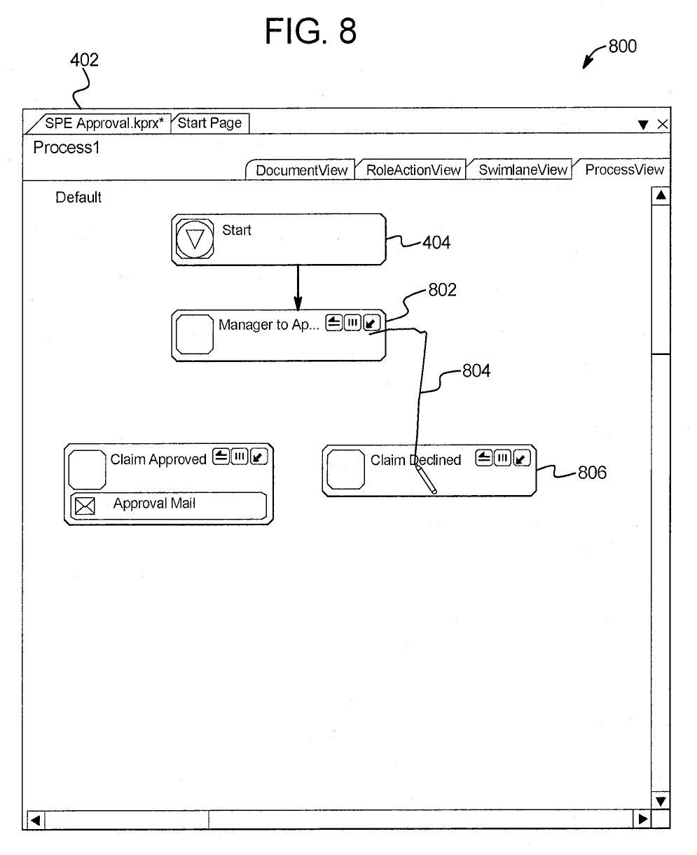

A screenshot of an example performing a gesture between two activities 800 is presented in FIG. 8. Although the example performing a gesture on between two activities 800 is described in reference FIG. 8, it will be appreciated that many other configurations are possible. For example, elements could be in different locations, elements could have different names, and elements could have different graphical representations.

A business process designer may wish to perform a gesture between two activities. For example, the business designer may wish to create a workflow path 902, between a Manager to Approve activity 802 and a Claim Declined activity 806. The business process designer may create a linking gesture 804 between the two activities.

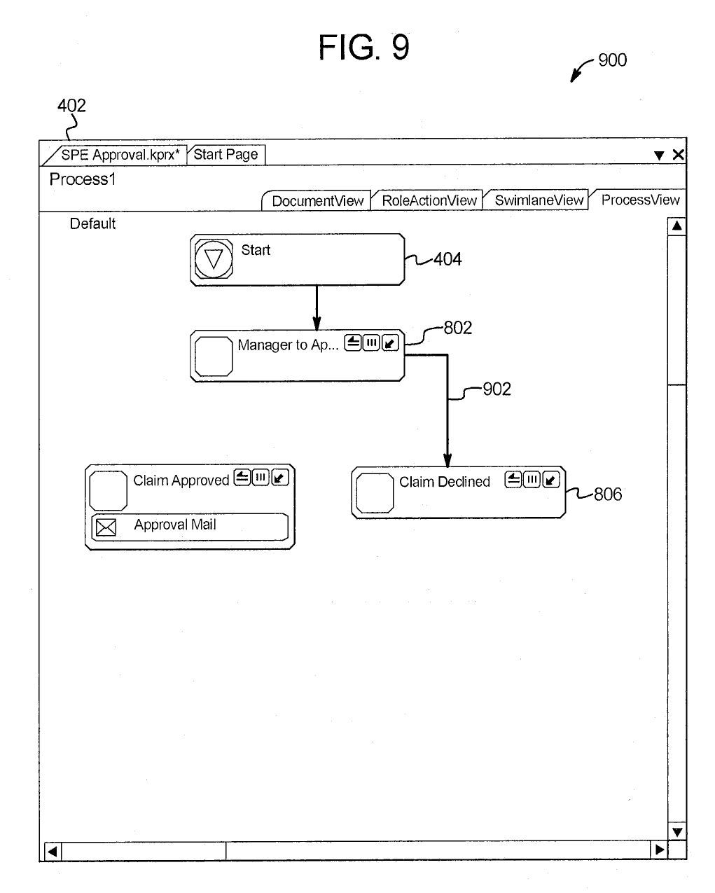

The gesture interpretation module 224 may receive the gesture 804 and determine the associated workflow path. For example, the gesture interpretation module 224 may search the storage unit 218 for a workflow activity that corresponds to a gesture connecting two activities and determine that the associated workflow activity is a workflow path. The gesture interpretation module 224 may then cause a new workflow path 902 to appear as shown in FIG. 9.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method for generating a workflow component using a gesture comprising:
associating the gesture with a workflow component;
receiving the gesture from an input device;
retrieving the workflow component associated with the gesture; and
inserting the workflow component into a workflow process.

2. The method of claim 1, wherein the input device is a mouse.

3. The method of claim 1, wherein receiving the gesture includes receiving the gesture from a plurality of input devices.

4. The method of claim 1, wherein the workflow component is selected from the group comprising activities, lines, steps, paths and events.

5. The method of claim 1, wherein receiving the gesture includes receiving a workflow activity that the gesture was performed on.

6. The method of claim 1, wherein inserting the workflow component includes displaying a workflow component configuration wizard.

7. The method of claim 1, wherein associating the gesture with a workflow component includes displaying a gesture association wizard.

8. The method of claim 1, wherein associating the gesture with a workflow component includes editing a gesture configuration file.

9. A system for generating a workflow component using a gesture, the system comprising:
a processor for associating the gesture with the workflow component;
a memory capable of storing the gesture and the associated workflow component;
an input device for inputting the gesture; and
a display for displaying the workflow component associated with the gesture.

10. The system of claim 9, wherein the input device is a mouse.

11. The system of claim 9, wherein receiving the gesture includes receiving the gesture from a plurality of input devices.

12. The system of claim 9, wherein the workflow component is selected from the group comprising activities, lines, steps, paths and events.

13. The system of claim 9, including a receiver for receiving a workflow activity that the gesture was performed on.

14. The system of claim 9, wherein the display additionally displays a workflow component configuration wizard.

15. The system of claim 9, wherein the display additionally displays a gesture association wizard.

16. The system of claim 9, wherein the processor accesses a gesture configuration file.

17. A computer readable medium storing instructions structured to cause a computing device to:
associate a gesture with a workflow component;
store the gesture and the associated workflow component;
receive the gesture from an input device; and
display the workflow component associated with the gesture.

18. The computer readable medium of claim 17, wherein the input device is a mouse.

19. The computer readable medium of claim 17, wherein the instructions are structured to cause the computing device to receive the gesture from a plurality of input devices.

20. The computer readable medium of claim 17, wherein the workflow component is selected from the group comprising activities, lines, steps, paths and events.

21. The computer readable medium of claim 17, wherein the instructions are structured to cause the computing device to receive a workflow activity that the gesture was performed on.

22. The computer readable medium of claim 17, wherein the instructions are structured to cause the computing device to display a workflow component configuration wizard.

23. The computer readable medium of claim 17, wherein the instructions are structured to cause the computing device to display a gesture association wizard.

24. The computer readable medium of claim 17, wherein the instructions are structured to cause the computing device to access a gesture configuration file.
